(19) United States
(12) Patent Application Publication
(10) Pub. No.: US 2015/0004979 A1
(43) Pub. Date: Jan. 1, 2015

(54) HETNET MEASUREMENT AND REPORTING ENHANCEMENT

(71) Applicant: SHARP KABUSHIKI KAISHA, Osaka (JP)

(72) Inventors: Zoltan SZALAY, Budapest (HU); Andrea FARKASVOLGYI, Budapest (HU); Zsolt SZABO, Budapest (HU); Shohei YAMADA, Camas, WA (US)

(21) Appl. No.: 13/927,792

(22) Filed: Jun. 26, 2013

(51) Int. Cl. H04W 36/00

(52) U.S. Cl. CPC H04W 36/0094
USPC 455/437; 455/550.1

(57) ABSTRACT

A wireless telecommunications network comprising a first cell and a user equipment (UE). The UE is operable to measure the RSRP for a communications channel and to monitor fluctuations of the RSRP so as to determine a quality factor for the channel. The UE is configured to determine a weighted RSRP using said quality factor, and report the weighted RSRP to its serving eNB.

### TECHNICAL FIELD

The present arrangement relates generally to ranking cells and handover processes in a mobile telecommunications system, and particularly introduces a measurement parameter, which can be used for a handover and a triggering condition in Long Term Evolution (LTE)-Advanced systems.

### BACKGROUND

LTE-A or LTE Advanced is currently being standardized by the 3GPP as an enhancement of LTE. LTE mobile communication systems are being deployed from 2010 onwards as a natural evolution of GSM and UMTS. The section below briefly discusses the network architecture of an LTE wireless communications network. Further details may be found at www.3gpp.org.

The base station—in E-UTRAN—for LTE consists of a single node, generally termed the eNodeB (eNB) that interfaces with a given mobile phone (typically termed user equipment, or user terminal). For convenience, the term UE—user equipment—will be used hereafter. The eNB is the radio access part of the UMTS/LTE system. Each eNB contains a radio transmitter, radio receiver, a control section and a power supply. eNB functions include radio resource management—RRM, radio bearer control, radio admission control—access control, connection mobility management, resource scheduling between UEs and eNB radios, header compression, link encryption of the user data stream, packet routing of user data towards its destination (usually to the EPC or other eNBs), scheduling and transmitting paging messages (incoming calls and connection requests), broadcast information coordination (system information), and measurement reporting (to assist in handover decisions). Each eNB is composed of an antenna system (typically a radio tower), building, and base station radio equipment.

Base station radio equipment consists of RF equipment (transceivers and antenna interface equipment), controllers, and power supplies.

Each eNB is associated with an area of coverage. This area of coverage may be defined by one or more cells (an eNB can have multiple co-located cells, or non-co-located cells deployed with fibre optic connections. These cells may operate on different frequencies). When a UE moves between cells, the radio link between the UE and the network is passed between eNBs. This procedure is termed a handover.

Initially, LTE networks comprised a plurality of eNBs that provided network coverage. The cells associated with the eNBs in this network that have large cell radius (often a few kilometres, and typically >0.5 km), are referred to as macro-cells. The cell in which the UE is currently attached is typically referred to as the serving cell.

Recently, the deployment of heterogeneous networks (HetNet) is becoming more common. This type of network provides enhanced network performance by acknowledging that there is usually an unequal demand in various parts of the network. For example, office blocks, trains stations, and the like typically require much higher usage than other areas. Thus, in heterogeneous networks, the current structure of eNBs will be complemented with a plurality of lower-power pico or femto eNBs that are deployed in areas of high demand. Such deployments should achieve significantly improved overall capacity and cell-edge performance in the network. These lower-power cells are often generically termed small-cells.

In LTE networks, measurements for serving and neighbouring cells are performed according to how the network configures the UEs to perform the measurements. This may be based on well-defined events, for example when the serving cell signal level falls below a threshold.

Serving cell measurements can be performed anytime. Whereas, to measure cells on other frequencies, a UE may require measurement gaps (gaps when the UE is not using that receiver for listening to any other signals from either its serving cell or other cells).

Each UE in the network performs certain measurements. One is to measure the Reference Signal Received Power (RSRP). The RSRP is the linear average of a reference signal power (in Watts) across a specified bandwidth in the network.

According to the current LTE specification, a UE measures the RSRP of both its serving cell and of neighbouring cells in the relevant bandwidth. The RSRPs are individually averaged for each channel, and each averaged result is reported back by UE to its serving eNB.

Measurement reports are sent from the UE to the network. The network specifies when the reports are to be sent. This may be periodical, or based on well-defined events (such as those defined in 3GPP TS36.331 Sec 5.5.4). It may also be a combination of event-based and periodicals. Typically the reports are generated with given periodicities.

LTE networks use a criteria called an s-measure. The s-measure is a value indicating to the UE when it should start measurement for neighbouring cells in preparation for a handover. If the UE determines that a cell's RSRP drops below a certain value (after L3 filtering), the UE will perform appropriate measurements of neighbouring cells on the frequencies and RATs indicated in the relevant measObject.

However, it is possible that the signal strength in a given cell may fluctuate. Significant fluctuations may affect data transfer between the UE and eNB. For HetNet environments fluctuations in signal strength in one or more cells may cause a UE to ‘ping-pong’ between cells. This refers to the undesirable situation where a UE handover alternates back and forth between two cells.

The present arrangement has been devised to address these problems.

### BRIEF DESCRIPTION OF THE INVENTION

According to the present invention there is provided a wireless telecommunications network comprising a first cell and a user equipment (UE), wherein said UE is operable to measure a reference signal received power (RSRP) for a radio link between said UE and said cell, wherein the UE is configured to monitor fluctuations of said RSRP and determine a quality factor for said radio link based on said fluctuations.

It is preferred that the cell comprises a eNB, wherein the UE is configured to determine a weighted RSRP using said quality factor, and report the weighted RSRP to the eNB.

It is advantageous to use the weighted RSRP because it provides a more exact description of the quality of a radio link (quality of signal) than the averaged RSRP because it takes into account the fluctuations of the RSRP rather than merely taking an average value. Additionally, the usage of the proposed weighted RSRP enhances the data transfer rate. Furthermore, the utilization of the weighted RSRP decreases the frequency of Handover failures and ping-pong effects.

Preferably the network comprises a plurality of cells, wherein said UE is operable to measure the RSRP for each of the cells, and calculate a weighted RSRP for each cell. It is particularly preferred that cells are ranked according to their respective weighted RSRPs. The ranking of cells according to their weighted RSRPs gives a ranking of the quality of the signal of each of the cells. Preferably the eNB performs the ranking. Alternatively, and equally preferred, the UE may perform the ranking. If the UE performs the ranking it is preferred that the UE reports the highest ranking cells to the eNB.

It is preferred that the network can deactivate the calculation of the weighted RSRP and/or the quality factor. In this arrangement the network reverts back to using the current LTE standard for the averaged RSRP.

It is preferred that the network comprises a heterogeneous network. It is particularly preferred that at least one of said plurality of cells and/or the first cell is a small-cell. In case of small cells/micro-cells and HetNet environments, the fluctuations of communication channel are more significant than in a macro cell environment. The reported averaged RSRP values of the current LTE standard cannot properly characterize the micro-cell environment. The frequency and the scale of channel fluctuations highly affect the rate of data transfer. Therefore, by ranking the cells and then selecting the cell with the best parameters leads to stronger communication channels, which in turn leads to an increase in data transfer. Also, Handover failure rate and ping-pong effects due to continual back-and-forth handovers between a micro-cell and a macro-cell can be reduced.

Preferably the quality factor is used to generate a trigger condition. It is preferred that, if the quality of the channel drops below a threshold level, the network will handover the UE to a cell with a high quality channel.

When the quality factor is less than a network specified threshold, it is representative of high and frequent attenuations in the channel, and thus representative of unsatisfactory channel quality. It is preferred that the quality factor is used to initiate a trigger event when its value is smaller than a threshold level over an interval configured by the network.

Preferably the weighted RSRP is calculated using a shifting average. It is preferred that the shifting average is determined over a time period set by the network.

It is preferred that a First in First out data structure is used to calculate the shifting average of the weighted RSRP. Because the number of averaged samples is constant, this method provides an accurate estimation of the average signal level. The width of the interval can be set in a function of the environment. Accordingly, the number of handover failures can be decreased, as well as reducing the number of ping-pong events. Another advantage is that the stored RSRP values can be used for additional analyses of the channel.

According to a second aspect of the present invention, there is provided an user equipment configured to monitor fluctuations in a wireless communication channel to an eNB by measuring RSRP values and determining when said measured values are above a threshold.

In a preferred arrangement, the threshold is established using a measured RSRP reference value and a parameter generated by the network.

Preferably the measured values are measured over a given time period. It is also preferred that the UE determines for how long in said time period the RSRP values are above the threshold, and, using said determination, obtains a coherence time.

It is preferred that the UE uses the coherence time to obtain a quality parameter for the channel.

It is also preferred that the quality parameter is used to obtain a weighted RSRP for the communication channel. In a preferred arrangement, the weighted RSRP is a product of the quality factor and the measured RSRP reference value.

It is preferred that the UE is configured to obtain weighted RSRP values for a plurality of cells, and rank said cells according to their respective weighted RSRPs.

These and other objects, advantages and features of the disclosure will become better understood from the detailed description of the disclosure that is described in conjunction with the accompanying drawings.

### BRIEF DESCRIPTION OF THE DRAWINGS

FIG. 1 shows an diagram of a cell arrangement in a wireless telecommunications network.

FIG. 2 shows a graph illustrating a quality indicator of a RSRP over time.

FIG. 3 shows a table detailing seven scenarios in relation to the present arrangement.

### DETAILED DESCRIPTION

The detailed description set out below references the LTE technical specification (TS). The TS may be found at www.3gpp.org.

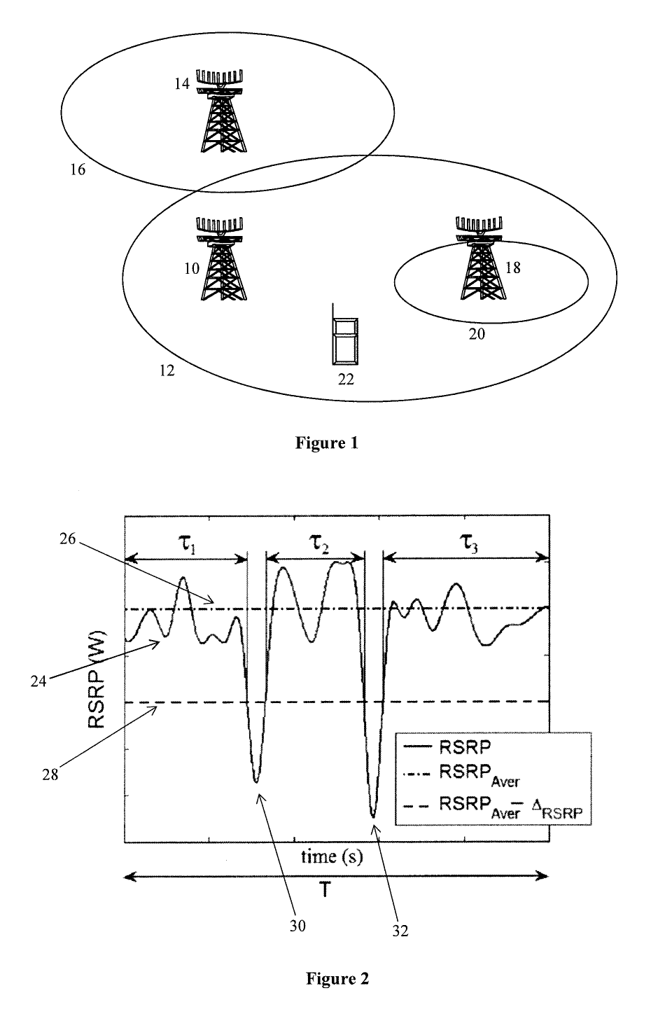

FIG. 1 shows a simplifies example of part of a wireless telecommunications network. There is provided a first cell 12 with an eNB 10 situated therein. Cell 16 and cell 20 are neighbour cells of cell 12. Each of cells 16 and 20 have respective eNBs 14, 18. Each of cells 12 and 16 are macro-cells, whilst cell 20 represents a small-cell contained within cell 12. A UE 22 is operable to move throughout the network. In FIG. 1 UE 22 is shown within cell 12. As such, cell 12 is the UE's serving cell. Cells 16 and 20 represent neighbouring cells. As the UE 22 approaches either cell 16 or cell 20 the network may handover the UE from eNB 10 to either eNB 14 or eNB 18, as appropriate.

In handover mechanisms, the LTE network relies on a number of measurements. One of these is the Reference Signal Received Power (RSRP). The RSRP is a measurement of the signal strength of an LTE cell and it aids ranking between different cells as input for handover and cell reselection decisions. The RSRP is the average of the power of all resource elements which carry cell-specific reference signals over the entire bandwidth.

According to the current LTE specification the UE measures the RSRP of the serving cell, and of relevant neighbouring cells. The RSRPs are individually averaged for each channel, and every averaged result is reported back by UE 22 to the serving eNB 10.

The UE 22 will be instructed by the network as to when to make RSRP measurements, and how often to report them back to the eNB 10. For example, the network could require the UE 22 to make periodic measurements and report each of them to its serving eNB 10. Alternatively, the UE 22 may be instructed to only report measurements to the eNB 10 when the signal level drops below a threshold value. The configuration of the measurements and their reporting back to the eNB is determined by the network.

FIG. 2 shows a plot 24 of the measured RSRP against time. An average value plot 26 of the RSRP (also referred to herein as RSRP_{averaged}) is also shown. However, it will be noted that plot 24 contains two downward spikes 30, 32 that are considerably lower that the average value 26. The spikes 30, 32 represent fluctuations in the RSRP, as measured by the UE 22.

The frequency and scale of channel fluctuations can highly affect the rate of data transfer between the UE 22 and the eNB 10. This situation is exacerbated in the case of small-cells. Current UE reported RSRP values in LTE networks do not adequately characterize HetNet environments. Particularly, the existing measurement method only calculates the linear average of the RSRP. It does not give a measure of the stability of the signal, particularly with regard to the instantaneous dropping of the signal level. Without information about such stability, the decision about the suitability of the cell (ranking) for Handover, may not be robust enough, especially for HetNet environments. Failure to account for such fluctuations in signal strength in one or more cells may lead to Handover failures or cause a UE to ‘ping-pong’ between cells.

In relation to small-cells contained within a macro-cell, it is advantageous to rank the cells according to measured parameters, and allow selection of the cell with the best parameters in determining whether or not to perform a handover to a micro-cell. This arrangement provides for an increase of the data transfer. Also, potential ‘ping-pong’ effects due to improper handovers can be reduced.

The frequency of the measurements performed by the UE in current LTE-A networks may be adapted to calculate one or more dynamic parameters to allow ranking of cells based on parameter values. A first dynamic parameter in the present arrangement is the coherence time. The coherence time of a communication channel is calculated by the UE to improve the Handover performance in LTE, particularly in a HetNet environment. The coherence time maybe considered as a type of autocorrelation, which shows the self similarity of the channel and gives a measure of the stability of the signal. This parameter may be calculated from the RSRPs measured by the UE 22.

The coherence time is an estimate for the fluctuations of the channels and can be used to characterize the quality of the serving and neighbouring cells. When the coherence time is combined with the averaged RSRP, it can provide a parameter to rank the cells seen by the UE in various environments. It is preferred that the coherence time is used to generate a quality factor.

The quality factor can be used to generate a triggering condition in order to perform a Handover when the attenuations of the channel are high and frequent (typically by using said coherence time to generate a quality factor). In this case the calculation of the MCS (Modulation/Coding Scheme) is difficult, inaccurate and the data transfer rate is low. The trigger condition may be associated with a TTT (Time To Trigger) parameter. The TTT parameter specifies a time for the UE to send a measurement report to its serving eNB, if a trigger condition exists during said TTT.

The coherence time for channel K (τ^{channel K}) can be calculated with the following procedure based on RSRP values measured according to existing LTE standards. For each radio connection, the variation of the measured RSRP values is detected making the comparison:

RSRPᵢ^{channel K}≧RSRP_{AVER}^{channel K}−Δ_{RSRP}, (1)

where RSRPᵢ^{channel K} is the actual value of the measured RSRP for channel K, RSRP_{average}^{channel K} is a reference value defined below, and Δ_{RSRP} is a parameter set by the network. When condition (1) is satisfied, then a counter is incremented:

counter^{channel K}=counter^{channel K}+1, (2)

When condition (1) is not satisfied, or reporting by the UE to the serving eNB is performed, the coherence time of channel K, τ^{channel K} is computed as:

τ^{channel K}=Tₛₗₒₜ×counter^{channel K}, (3)

where Tₛₗₒₜ is the time interval of consecutive RSRP measurements. The calculation of coherence time is restarted when condition (1) is again satisfied or after reporting was performed. Thus, channel K can be characterized with a quality factor:

$${Q}^{channel K} = \frac{{\sum }_{i} {τ}_{i}^{channel K}}{T} , \qquad ( 4 )$$

The measurement of the quality factor Q is performed over a time interval T, which equals the interval between two measurement reports from the UE to the serving eNB. This parameter varies in the interval Q^{channel K}ε[0,1] continuously. When Q^{channel K} is close to one, the channel is relatively constant and there are no significant fluctuations. When Q^{channel K} is small, the channel strongly fluctuates.

The quality factor Q can be applied to rank the cells detected by the UE. The measure to rank the channels can be the weighted RSRP parameter Q^{channel K}×RSRP_{averaged}^{channel K}, where RSRP_{averaged}^{channel K} is the LTE parameter (the averaged RSRP for channel K), which is reported to eNB in the current standard. When the rank of two channels is equal, it is preferred that the cell with higher quality factor Q is selected.

Δ_{RSRP} is a parameter set by the network operator. It may be set arbitrarily, or adapted using historical data. The Δ_{RSRP} parameter may be changed by the network depending on network conditions.

In the present arrangement, the UE 22 reports a weighted RSRP(Q^{channel K}×RSRP_{averaged}^{channel K}) to its serving eNB 10 instead of the RSRP_{averaged}^{channel K} (as it would under existing arrangements) because the weighted value provides a more exact description of the quality of the serving or neighbouring cells.

It will be appreciated that when Δ_{RSRP}=RSRPₐᵥₑᵣ, the quality parameter Q=1 and the averaged RSRP of the existing standard is reported. All trigger conditions and TTTs of the current LTE specification can be utilized along with the weighted RSRP parameter.

The ranking of the cells can be made by the UE or by the eNB. When the ranking is performed by the UE, it is preferred that the cells with the optimum parameters are reported to eNB.

The quality parameter Q may be applied as a triggering condition for the UE to send a report to the eNB. When Q^{channel K}<C_{TrEvent}, where C_{TrEvent} is a parameter set by the network, it can be considered that high attenuations are frequent in the communication channel. Therefore, the quality of the channel may not be sufficient to support required data transfer. The quality parameter Q^{channel K} may be used to initiate a trigger event when its value is smaller than C_{TrEvent} over a TTT interval. The TTT interval is preferably configured by the network.

Whilst the usage of the trigger condition requires additional calculation from the UE, there are numerous advantages. For example, a trigger condition based on a quality factor Q provides information about the stability of a given channel, and therefore the utilization of such a trigger condition can increase the data transfer rate.

The averaged RSRP can be calculated in a number of ways. A preferred first embodiment calculates the value with a shifting average. This method requires T_{periodic}/T_{Slot} number of stored mot measured RSRP values. The measured values are catalogued in a First-in First-out (FIFO) data structure. The value of the averaged RSRP is generated by the arithmetical mean of the data stored in FIFO.

This arrangement provides an accurate estimation of the average RSRP, and, furthermore, the stored data can allow additional channel analyses.

The averaged RSRP, which is reported by the UE to the Serving eNB, is preferably calculated with a shifting average. This is implemented with a new parameter—T_{window}—which defines the width of the shifting window. This parameter is set by the network. The width of the shifting window may be adaptable according to demands. The width of the window T_{window} can be set in function of the environment, therefore the number of handover failures can be decreased. Additionally, the number of ping-pong events is reduced. Because the number of averaged samples is constant, the method provides for a more accurate estimation of the average signal level.

It will be appreciated that the usage of a shifting average to obtain the averaged RSRP requires additional calculation from the UE over current arrangements.

A second embodiment calculates the averaged RSRP between the second to last and last report from the UE to the eNB to calculate a quality factor. The averaged RSRP of the Release 11 LTE may be used as the reference value. This value is readily available and is required to be stored by the UE in current configurations, thus no additional calculations are required. However, the last and actual averaged RSRP can slightly differ, and this error may affect the accuracy of the ranking.

A third embodiment calculates the averaged RSRP with a cumulative average. The averaging is initiated with the averaged RSRP calculated between the second to last and last reporting. When a new RSRP measurement is performed by the UE, the reference RSRP is updated with the arithmetical mean value of the measured RSRP and the previous reference RSRP. The averaging of the measured RSRP values over the time interval T is also performed. The method provides a more accurate estimate of the averaged RSRP valid for the current time interval T than the previous solution.

There may be times in the operation of the network where the present arrangement cannot be supported. Therefore, it is preferred that the weighted RSRP function may be deactivated, with the system reverting back to present systems. For example, the calculation of the weighted RSRP can be turned off with one of the following methods.

Firstly, when the network cannot support the procedure, the default parameter for the UE is Δ_{RSRP}=RSRPₐᵥₑᵣ. In this case the quality parameter Q^{channel K}=1, and the averaged RSRP of the existing LTE standard is reported to the eNB.

Alternatively, a flag in the UE may be implemented, which can turn off the weighted RSRP calculation when the network cannot support it. The ranking is turned on automatically by this flag when the network configures Δ_{RSRP}. This arrangement is advantageous in that it preserves battery life of the UE.

To aid in understanding the present arrangement, a series of scenarios are set out below. These scenarios are particularly applicable to small-cells contained within a macro-cell, but it should be appreciated that the present arrangement may be used in any measurement reporting process.

Scenario 1: The averaged RSRP of the serving cell is higher than the averaged RSRP of the neighbouring cells and the stability of the serving cell Q^{SCell} is higher than the stability of the neighbouring cells Q^{NCells} consequently the weighted RSRP of the serving cell is higher than the weighted RSRP of the neighbouring cells. In this case no triggered measurement report is sent to the eNB.

Scenario 2: The averaged RSRP of the serving cell is higher than the averaged RSRP of the neighbouring cells and the stability of the serving cell Q^{SCell} is smaller than the stability of the neighbouring cells Q^{NCells}, however the weighted RSRP of the serving cell is larger than the weighted RSRP of the neighbouring cells. In this case no triggered measurement report is sent to the eNB.

Scenario 3: The averaged RSRP of the serving cell is higher than the averaged RSRP of the neighbouring cells and the stability of the serving cell Q^{SCell} is smaller than the stability of the neighbouring cells Q^{Ncells}, however the weighted RSRP of the serving cell is smaller than the weighted RSRP of one neighbouring cell. In this case, when the s-measure criterion is fulfilled triggered measurement report is sent to the eNB.

Scenario 4: The averaged RSRP of the serving cell is smaller than the averaged RSRP of the neighbouring cells and the stability of the serving cell Q^{SCell} is smaller than the stability of the neighbouring cells Q^{NCells}, consequently the weighted RSRP of the serving cell is smaller than the weighted RSRP of the neighbouring cells. In this case, when the s-measure criterion is fulfilled a triggered measurement report is sent to the eNB.

Scenario 5: The averaged RSRP of the serving cell is smaller than the averaged RSRP of the neighbouring cells and the stability of the serving cell Q^{SCell} is larger than the stability of the neighbouring cells Q^{NCells}, however the weighted RSRP of the serving cell is larger than the weighted RSRP of one neighbouring cell. In this case no triggered measurement report is sent to the eNB.

Scenario 6: The averaged RSRP of the serving cell is smaller than the averaged RSRP of the neighbouring cells and the stability of the serving cell Q^{SCell} is larger than the stability of the neighbouring cells Q^{NCells}, however the weighted RSRP of the serving cell is smaller than the weighted RSRP of one neighbouring cell. In this case, when the s-measure criterion is fulfilled a triggered measurement report is sent to the eNB.

Scenario 7: When the network cannot support the proposed procedure the default parameter for the UE is Δ_{RSRP}=RSRPₐᵥₑᵣ. In this case the quality parameter Q=1, and the averaged RSRP of the existing standard is reported.

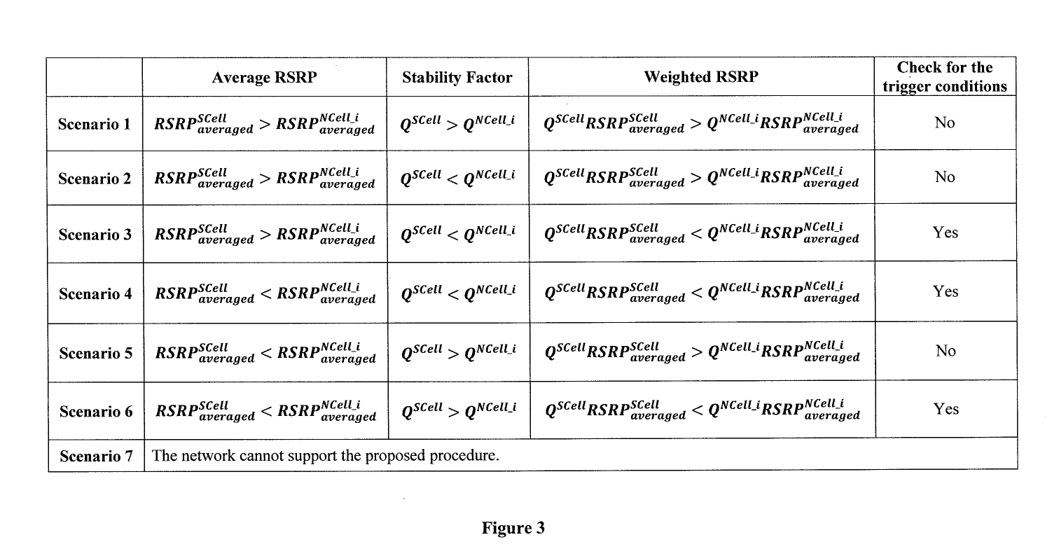

The operation scenarios are summarized in FIG. 3.

The following provides a proposal to alter the LTE technical standards.

Introduction of weighted average RSRP: 3GPP TS 36.331 5.5.3 Performing measurements

### 5.5.3.1 General

For all measurements the UE applies the layer 3 filtering as specified in 5.5.3.2, before using the measured results for evaluation of reporting criteria or for measurement reporting.

### The UE Shall:

1>whenever the UE has a measConfig, perform RSRP and RSRQ measurements for each serving cell, applying for the PCell the time domain measurement resource restriction in accordance with measSubframePatternPCell, if configured;
2>whenever the UE is configured with enabling weighted RSRP/RSRQ:
3>perform the weighted average RSRP and RSRQ measurements for each serving cell,
1>for each measId included in the measIdList within VarMeasConfig:
2>if the purpose for the associated reportConfig is set to reportCGI:
3>if si-RequestForHO is configured for the associated reportConfig:
4>perform the corresponding measurements on the frequency and RAT indicated in the associated measObject using autonomous gaps as necessary;
3>else:
4>perform the corresponding measurements on the frequency and RAT indicated in the associated measObject using available idle periods or using autonomous gaps as necessary;

Note0: Weighted average RSRP is the multiplication of shifting average RSRP and channel quality factor, which is the fluctuation of channels during a predefined time interval.

Usage of Ranking factor, Shifting average of RSRP and channel quality factor in specification 3GPP TS 36.331 V11.2.0 (2012-12);

### 5.5.5 Measurement Reporting

1>if the reportConfig associated with the measId that triggered the measurement reporting includes reportAddNeighMeas:
2>for each serving frequency for which measObjectId is referenced in the measIdList, other than the frequency corresponding with the measId that triggered the measurement reporting:
3>set the measResultServFreqList to include within measResultBestNeighCell the physCellId and the quantities of the best non-serving cell, on the concerned serving frequency;
4>if configured, based on weighted average RSRP,
4>else based on RSRP

Note0: Channel quality factor is the fluctuation of channels during a predefined time interval.

3>for each cell that is included in the measResultNeighCells, include the physCellId;
3>if the triggerType is set to event; or the purpose is set to reportStrongestCells or to reportStrongestCellsForSON:
4>for each included cell, include the layer 3 filtered measured results in accordance with the reportConfig for this measId, ordered as follows:
5>if the measObject associated with this measId concerns E-UTRA:
6>set the measResult to include the quantity(ies) indicated in the reportQuantity within the concerned reportConfig in order of decreasing trigger Quantity, i.e. the best cell is included first.

Thus, based on the described embodiments, it will be appreciated that the present arrangement discloses a wireless telecommunications network comprising a first cell and a UE, wherein the UE can measure a RSRP for a radio link between said UE and said cell, and is configured to monitor fluctuations of said RSRP and determine a quality factor for said radio link based on said fluctuations.

Typically, the first cell comprises an eNB. The UE is configured to determine a weighted RSRP using said quality factor, and report the weighted RSRP to the eNB.

The network typically comprises a plurality of cells, wherein said UE is operable to measure the RSRP for each of the cells as configured by the network, and calculate a weighted RSRP for each cell. The cells are ranked according to their respective weighted RSRPs.

Either the eNB or the UE may perform the ranking. If the UE performs the ranking, preferably the UE only reports the highest ranking cells to the eNB.

The network can deactivate the calculation of the weighted RSRP and/or the quality factor.

Typically, the network comprises a heterogeneous network. In this at least one of said plurality of cells and/or the first cell is a small-cell.

The quality factor is used to generate a trigger condition, such that, if the quality of the radio link drops below a threshold level, the network will handover the UE to a cell with a higher quality radio link.

The weighted RSRP may be calculated using a shifting average. The shifting average is typically determined over a time period set by the network. Preferably a first in first out data structure is used.

It will also be appreciate that there is disclosed a UE configured to monitor fluctuations in a wireless communication channel/radio link to an eNB by measuring RSRP values and determining when said measured RSRP values are above a threshold. The threshold is established using a measured RSRP reference value and a parameter generated by the network.

Typically, the measured RSRP values are measured over a given time period, and the UE determines for how long in said time period the RSRP values are above the threshold, and uses said determination to obtain a coherence time. The UE uses the coherence time to obtain a quality parameter for the wireless communication channel. Consequently, the quality parameter is used to obtain a weighted RSRP for the communication channel. The weighted RSRP is a product of the quality factor and the measured RSRP reference value. In preferred arrangements, the UE is configured to obtain weighted RSRP values for a plurality of cells, and rank said cells according to their respective weighted RSRPs.

It will be appreciated that the present arrangement can be applied in arbitrary environments as HetNet, macro-cells or small-cells. It provides the possibility of more accurate characterization of the quality of the cells than is possible with the current LTE specification. The implementation of the proposed parameters can allow manufacturers to develop new handover algorithms to improve the mobility in the HetNet environment with small modifications of the existing standard.

The advantages of the present arrangement are achieved by the provision of a dynamic parameter: the coherence time. The coherence time is calculated by the UE based on existing measured parameters, the RSRPs.

Using the coherence time, a quality factor, that measures the fluctuations of the serving cell, may be calculated. Thus it becomes possible to characterize the quality of the channel.

The ranking of the serving and neighbouring cells can be made with the weighted RSRP parameter that is determined by applying the quality factor. By using the weighted RSRP data transfer rate can be increased by better ranking the neighbouring cells in preparation of Handover.

A consequence of implementing the above parameters is the reduction of ping-pong effects due to improper handovers.

The forgoing descriptions of the preferred embodiments of the disclosure have been presented for purposes of illustration and description. They are not intended to be exhaustive or to limit the invention to the precise arrangements disclosed. Obvious modifications and variations are included within the scope of the claims

1. A wireless telecommunications network comprising a first cell and a user equipment (UE), wherein said UE is operable to measure a reference signal received power (RSRP) for a radio link between said UE and said cell, wherein the UE is configured to monitor fluctuations of said RSRP and determine a quality factor for said radio link based on said fluctuations.

2. A wireless telecommunications network according to claim 1, wherein the first cell comprises an eNB, wherein the UE is configured to determine a weighted RSRP using said quality factor, and report the weighted RSRP to the eNB.

3. A wireless telecommunications network according to claim 2, wherein the network comprises a plurality of cells, wherein said UE is operable to measure the RSRP for each of the cells as configured by the network, and calculate a weighted RSRP for each cell.

4. A wireless telecommunications network according to claim 3, wherein the cells are ranked according to their respective weighted RSRPs.

5. A wireless telecommunications network according to claim 4, wherein the eNB performs the ranking.

6. A wireless telecommunications network according to claim 4, wherein the UE performs the ranking.

7. A wireless telecommunications network according to claim 6, wherein the UE reports the highest ranking cells to the eNB.

8. A wireless telecommunications network according to claim 2, wherein the network can deactivate the calculation of the weighted RSRP and/or the quality factor.

9. A wireless telecommunications network according to claim 3, wherein the network comprises a heterogeneous network.

10. A wireless telecommunications network according to claim 9, wherein at least one of said plurality of cells and/or the first cell is a small-cell.

11. A wireless telecommunications network according to claim 1, wherein the quality factor is used to generate a trigger condition, such that, if the quality of the radio link drops below a threshold level, the network will handover the UE to a cell with a higher quality radio link.

12. A wireless telecommunications network according to claim 2, wherein the weighted RSRP is calculated using a shifting average.

13. A wireless telecommunications network according to claim 12, wherein the shifting average is determined over a time period set by the network.

14. A wireless telecommunications network according to claim 13, wherein a first in first out data structure is used to calculate the shifting average of the weighted RSRP.

15. An user equipment (UE) configured to monitor fluctuations in a wireless communication channel to an eNB by measuring reference signal received power (RSRP) values and determining when said measured RSRP values are above a threshold.

16. An user equipment according to claim 15, wherein the threshold is established using a measured RSRP reference value and a parameter generated by the network.

17. An user equipment according to claim 15, wherein the measured RSRP values are measured over a given time period, and the UE determines for how long in said time period the RSRP values are above the threshold, and uses said determination to obtain a coherence time.

18. An user equipment according to claim 15, wherein the UE uses the coherence time to obtain a quality parameter for the wireless communication channel.

19. An user equipment according to claim 18, wherein the quality parameter is used to obtain a weighted RSRP for the communication channel.

20. An user equipment according to claim 19, wherein the weighted RSRP is a product of the quality factor and the measured RSRP reference value.

21. An user equipment according to claim 20, wherein the UE is configured to obtain weighted RSRP values for a plurality of cells, and rank said cells according to their respective weighted RSRPs.
